(19) United States
(12) Patent Application Publication
(10) Pub. No.: US 2012/0324249 A1
(43) Pub. Date: Dec. 20, 2012

(54) COMPUTER MOTHERBOARD

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen)., LTD., Shenzhen City (CN)

(21) Appl. No.: 13/331,465

(22) Filed: Dec. 20, 2011

(30) Foreign Application Priority Data
Jun. 15, 2011 (CN) 201110159807.6

(51) Int. Cl. G06F 1/26

(52) U.S. Cl. 713/300

(57) ABSTRACT

A motherboard includes a CPU socket, a BIOS chip, a Southbridge chip, and a voltage regulator module (VRM). The BIOS chip is configured for rendering a BIOS UI. The BIOS UI includes a voltage setting menu, the voltage setting menu includes a number of voltage setting options, each of which, when selected, determines a unique voltage setting. The Southbridge chip is configured for storing the voltage setting and generating a unique voltage setting signal corresponding to the voltage setting. The VRM is configured for converting an input voltage into a supply voltage for the CPU socket according to the voltage setting signal.

### BACKGROUND

1. Technical Field

The present disclosure relates to computer motherboards, and particularly to a motherboard that uses power efficiently.

2. Description of Related Art

Some motherboards provide a fixed supply voltage to an onboard central processing unit (CPU). These motherboards are typically designed to be compatible with different types of CPUs, which have different processing capacities and require different voltages. However, the price for compatibility is wasted energy, as the motherboard is simply set to, at all times, provide a voltage equal to or greater than the highest anticipated needed voltage, which wastes energy if the installed CPU requires less than the set voltage.

Therefore, it is desirable to provide a motherboard, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a circuit diagram of a motherboard, according to an embodiment.

FIG. 2 is a schematic view showing a basic input output system (BIOS) user interface (UI) rendered by the motherboard of FIG. 1.

### DETAILED DESCRIPTION

Embodiments of the present disclosure will now be described in detail with reference to the drawings.

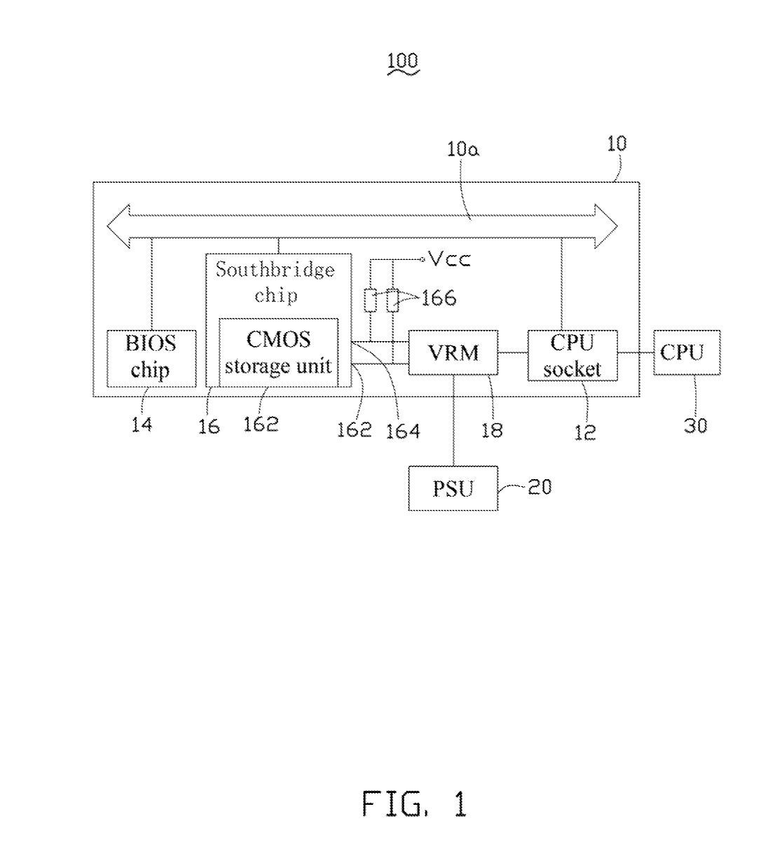

Referring to FIG. 1, a motherboard 10, according to an embodiment, can be applied to a computer 100. The computer 100 includes a power supply unit (PSU) 20. The motherboard 10 includes a CPU socket 12, a BIOS chip 14, a Southbridge chip 16, and a voltage regulator module (VRM) 18.

The CPU socket 12 is configured for receiving a CPU 30, that is to say, the CPU 30 is an element of the computer 100. The CPU 30 can be selected from three types of CPUs, each of which requires a unique voltage, for example, a first, second, or third voltage. In other words, the CPU socket 12 is compatible with three types of CPUs.

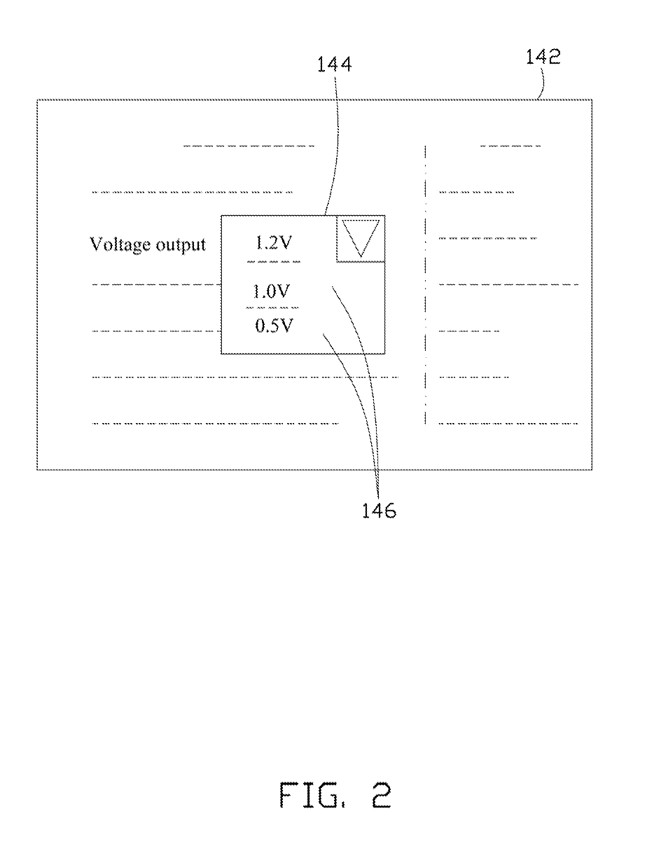

Also referring to FIG. 2, the BIOS chip 14 is configured for rendering a BIOS UI 142. The BIOS UI 142 includes a voltage setting menu 144. The voltage setting menu 144 includes three voltage setting options 146, for example, a “1.2V”, “1.0V”, or “0.5V” voltage setting option. Each of the voltage setting options 146, when selected in response to a user input, determines a unique voltage setting, for example, a first voltage setting when the “1.2V” voltage setting option is selected, a second voltage setting when the “1.0V” voltage setting option is selected, or a third voltage setting when the “0.5V” voltage setting option is selected.

The Southbridge chip 16 is configured for storing the voltage setting and generating a unique voltage setting signal corresponding to the voltage setting, for example, a first voltage setting signal corresponding to the first voltage setting, a second voltage setting signal corresponding to the second voltage setting, or a third voltage setting signal corresponding to the third voltage setting.

In particular, the BIOS settings of the computer 100 is comprised of hardcoded BIOS settings and user BIOS settings, and is first run by the computer 100, e.g., the CPU 30, when the computer 100 is powered on by the PSU 20 to initialize the computer 100. The hardcoded BIOS settings is built into the BIOS chip 14, which is typically a non-volatile read-only memory (ROM) chip. The Southbridge chip 16 includes a complementary metal-oxide semiconductor (CMOS) memory 162. The user BIOS settings are stored in the CMOS memory 162 and can be rewritten to allow hardware reconfiguration of the computer 200. The motherboard 10 further includes a bus 10a. The BIOS chip 14 and the Southbridge chip 16 are connected to the CPU socket 14 via the bus 10 and thus communicate with the CPU 30.

The BIOS UI 142 is typically a menu system accessed by pressing a certain key on a keyboard of the computer 200 when the computer 200 starts and is displayed on a display of the computer 200. Users are allowed to configure hardware of the computer 200 using the BIOS UI 142.

The voltage setting is one of the user BIOS settings and the voltage setting menu 144 is used to set a supply voltage for the CPU socket 12.

The VRM 18 is configured for converting an input voltage of the PSU 20 to a supply voltage according to the voltage setting signal.

The Southbridge chip 16 is connected to the VRM 18 via general purpose input output (GPIO) interfaces 162, 164 and the voltage setting signal is sent to the VRM 18 via the GPIO interfaces 162, 164. In detail, the GPIO interfaces 162, 164 are connected to a direct current (DC) power source Vcc via respective pull-up resistors 166. As such, the GPIO interfaces 162, 164 are pulled up to a logic high level before the Southbridge chip 16 grounds the GIPO interfaces 162, 164 according to the voltage setting. The Southbridge 16 sends the voltage setting signal to the VRM 18 by selectively grounding the GPIO interfaces 162, 164 according to the voltage setting.

For example, if the “1.2V” voltage setting option is selected and stored in the Southbridge chip 16 (i.e., the CMOS memory 162), the Southbridge chip 16 does not ground the GPIO interfaces 162, 164 and accordingly the GIPO interfaces 162, 164 remain at the logic high level. The logic high levels function as the voltage setting signal and signal the VRM 18 to convert the input voltage from the PSU 20 into the first voltage, e.g., 1.5V.

If the “1.0V” voltage setting option is selected and stored in the Southbridge chip 16, the Southbridge chip 16 grounds the GPIO interface 162 to a logic low level while leaving the GPIO interface 164 at the logic high level. The logic low level of the GPIO interface 162 and the logic high level of the GPIO interface 164 together function as the voltage setting signal and signals the VRM 18 to convert the input voltage from the PSU 20 into the second voltage, e.g., 1V.

If the “0.5V” voltage setting option is selected and stored in the Southbridge chip 16, the Southbridge chip 16 grounds the GPIO interface 164 to the logic low level but leaves the GPIO interface 162 at the logic high level. The logic high level of the GPIO interface 162 and the logic lower level of the GPIO interface 164 cooperatively function as the voltage setting signal and signals the VRM 18 to convert the input voltage from the PSU 20 into the second voltage, e.g., 0.7V.

In operation, a user can access the BIOS UI 142 and select the corresponding voltage setting option 146 according to the specification, i.e., the power rating, of the CPU 30. Then, the corresponding voltage setting is stored in the CMOS memory 162 and the corresponding voltage setting signal is sent by the Southbridge chip 16 to the VRM 18 to signal the VRM 18 to convert an input voltage from the PSU 20 to the corresponding supply voltage.

In other embodiments, the CPU socket 12 can be configured to be compatible more or less with three types of CPUs. In addition, the motherboard 10 can include more than one CPU socket 12 to receive and be compatible with more than one CPU of same or different types at the same time.

Accordingly, the voltage setting menu 144 can include more or less than three voltage setting options 146 and the Southbridge chip 16 can includes more or less than two GPIO interfaces to generate the voltage setting signal.

Moreover, the Southbridge chip 16 can signal the VRM 18 using other technologies than described in this embodiment.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A motherboard, comprising:
a CPU socket;
a BIOS chip configured for rendering a BIOS UI, the BIOS UI comprising a voltage setting menu, the voltage setting menu comprising a plurality of voltage setting options, each of which, when selected, determines a unique BIOS setting;
a Southbridge chip configured for storing the BIOS setting and generating a unique voltage setting signal according to the BIOS setting; and
a VRM configured for converting an input voltage into a unique supply voltage for the CPU socket according to the voltage setting signal.

2. The motherboard of claim 1, wherein the Southbridge chip is connected with the VRM via at least one GPIO interface and the voltage setting signal is sent from the Southbridge chip to the VRM via the at least one GIPO interface.

3. The motherboard of claim 2, wherein the at least one GPIO interface are pulled up to a high logic level and the Southbridge chip generating the voltage setting signal by selectively grounding the at least one GPIO interface to a logic low level according to the voltage setting.
